(19) United States
(12) Patent Application Publication
(10) Pub. No.: US 2019/0156976 A1
(43) Pub. Date: May 23, 2019

(54) DUST CORE AND METHOD FOR PRODUCING SAME

(71) Applicant: Panasonic Intellectual Property Management Co., Ltd., Osaka (JP)

(72) Inventors: MITSUO SAITOH, Osaka (JP); YOSHIE TAKAHASHI, Osaka (JP); TAKAO KUROMIYA, Osaka (JP); TOSHIYUKI KOJIMA, Kyoto (JP)

(21) Appl. No.: 16/300,232

(22) PCT Filed: Apr. 4, 2017
(86) PCT No.: PCT/JP2017/014055

§ 371 Date: Nov. 9, 2018

(30) Foreign Application Priority Data
Jun. 8, 2016 (JP) 2016-114656

(51) Int. Cl. H01F 1/153; H01F 1/24; H01F 41/02; B22F 9/04

(52) U.S. Cl. CPC H01F 1/15325; H01F 1/15333; B82Y 40/00; H01F 41/0246; B22F 9/04; H01F 1/24

(57) ABSTRACT

A dust core including an iron-based magnetic powder containing iron as a main component, including: a first magnetic powder which has a first peak in a particle size distribution of the iron-based magnetic powder; and a second magnetic powder which has a second peak corresponding to a particle size larger than a particle size corresponding to the first peak in the particle size distribution of the iron-based magnetic powder, and of which a crystal structure is nanocrystal or amorphous, in which a particle of the first magnetic powder and a particle of the second magnetic powder are in a state of being bonded to each other.

### TECHNICAL FIELD

The present disclosure relates to a magnetic powder used for an inductor such as a choke coil, a reactor, a transformer, and a dust core formed of the magnetic powder and a method for producing the same.

BACKGROUND ART

In recent years, high market growth has been anticipated in automobile driving support systems of automobiles, and demands for cameras and sensors for sensing people and things have been getting more severe. In accordance with the automatic operation system market, with demands for miniaturization and weight reduction of various electronic components, higher magnetism has been required for a soft magnetic core used for a choke coil, a reactor, a transformer, and the like.

In order to realize high magnetism of this soft magnetic core, it is considered that roughly two kinds of approaches are required. The first approach is a material approach that can achieve both high saturation magnetic flux density and high relative magnetic permeability (low loss). Specifically, in recent years, mainly practical application of an iron-based magnetic powder has been progressing, but the approach is to recrystallize a nanocrystal phase in an amorphous phase so that both phases are mixed. With this configuration, it is possible to realize a high level of magnetism which cannot be realized with a silicon steel plate or the like. The second approach is a manufacturing method of molding powders with a high filling rate as possible when preparing a soft magnetic core such as a dust core from powders of a magnetic body as a starting material.

In other words, with two types of approaches of an iron-based magnetic powder that can control a nanocrystal structure and a manufacturing method of molding at a high filling rate using powders of a magnetic body, development has been progressing in various fields aiming for a dust core with high magnetic properties that cannot be achieved with conventional soft magnetic cores.

For example, in PTL 1, a Fe-based amorphous thin band is set as a starting raw material, and is subjected to a general heat treatment such as resistance heating and infrared heating so as to form a nanocrystal soft magnetic alloy powder by processing an αFe (—Si)) crystal phase in an amorphous phase to be partially precipitated, a granulated powder is produced by mixing binder such as phenolic resin and silicone resin having excellent insulating properties and high heat resistance to the nanocrystal soft magnetic alloy powder, a mold is filled with the granulated powder, pressure molding is performed to form a compacted material, and then after the heat treatment again, additional precipitation of αFe (—Si) crystal phase and heat curing of the binder are performed at the same time. With these producing methods, a metal composite type dust core is produced as a soft magnetic core.

### CITATION LIST

### Patent Literature

PTL 1: Japanese Patent Unexamined Publication No. 2015-167183

### SUMMARY

In order to achieve the above object, a dust core according to the present disclosure which is including an iron-based magnetic powder containing iron as a main component includes a first magnetic powder having a first peak in a particle size distribution of the iron-based magnetic powder, and a second magnetic powder which has a second peak corresponding to a particle size larger than a particle size corresponding to the first peak in the particle size distribution of the iron-based magnetic powder, and of which a crystal structure is nanocrystal or amorphous, and a particle of the first magnetic powder and a particle of the second magnetic powder are in a state of being bonded to each other.

In addition, a method for producing a dust core according to the present disclosure includes a step of mechanically crushing an iron-based magnetic base material containing iron as a main component so as to form a magnetic powder having an outer diameter smaller than an outer diameter before crushing, a step of subjecting the magnetic powder to a heat treatment so as to form nanocrystal inside a particle of the magnetic powder, a step of heating a vicinity of a surface of the magnetic powder so as to remove a protrusion portion on a particle surface of the magnetic powder or melting an acute angle portion of the particle surface so as to make a shape close to a spherical surface, and a step of press-molding a magnetic powder mixed by using magnetic powders having two or more kinds of sizes in which at least the surface is treated by the heat treatment.

As desired above, according to the dust core of the present disclosure, it is possible to provide an iron-based magnetic powder which can be compatible with a high filing rate while securing a desired nanocrystal structure, and a dust core which can be realized by using the powder, and has low core loss and high relative magnetic permeability.

### BRIEF DESCRIPTION OF DRAWINGS

FIG. 1 is a diagram illustrating a sectional structure of a dust core according to a first embodiment.

FIG. 2 is a flowchart of a method for producing the dust core according to the first embodiment.

### DESCRIPTION OF EMBODIMENTS

Prior to description of embodiments, problems in the related art will be briefly described.

In the background art, in the dust core using a nanocrystal magnetic alloy powder illustrated in the first related art, it was required to mix not a little binder for maintaining a shape as the dust core after molding, and there was a limit to a filling rate to the powder.

On the other hand, without using the binder, a method for producing a dust core in which the powders are sintered by thermal diffusion can be easily conceived.

However, in a case of using an iron-based nanocrystal magnetic alloy powder as in the related art example, a heat treatment at a high temperature of approximately 800° C. to 1000° C. inclusive was required in order to thermally diffuse iron having a high melting point of 1536° C. on the particle surface and bond the particles to each other; whereas it was necessary to suppress the heating temperature to a temperature range of approximately 400° C. to 500° C. inclusive in order to maintain a nanocrystal structure inside the particle.

That is, there was a limit to obtain a high filling rate (or sintered body structure of particles) while securing a desired nanocrystal structure, and thereby the dust core was not able to be realized.

In other words, it was not easy to realize both securing a desired crystal structure and high filling rate, and there was a limit to the magnetism of the dust core.

The present disclosure is made to solve the above problems in the related art, and an object thereof is to provide an iron-based magnetic powder which can be compatible with a high filing rate while securing a desired nanocrystal structure, and a dust core using the powder.

According to a first aspect, there is provided a dust core formed of an iron-based magnetic powder containing iron as a main component including a first magnetic powder having a first peak in a particle size distribution of the iron-based magnetic powder, and a second magnetic powder which has a second peak corresponding to a particle size larger than a particle size corresponding to the first peak in the particle size distribution of the iron-based magnetic powder, and of which crystal structure is nanocrystal or amorphous, and a particle of the first magnetic powder and a particle of the second magnetic powder are in a state of being bonded to each other.

In the dust core of a second aspect according to the first aspect, the first magnetic powder may contain more carbon than the second magnetic powder contains.

In the dust core of a third aspect according to the first aspect, the first magnetic powder may contain more oxygen atoms than the second magnetic powder contains.

In the dust core of a fourth aspect according to the first aspect, the second magnetic powder may have an average of the crystal particle size in a range of 5 nm to 30 nm inclusive.

According to a fifth aspect, there is provided a method for producing a dust core including a step of mechanically crushing an iron-based magnetic base material containing iron as a main component so as to form a magnetic powder having an outer diameter smaller than an outer diameter before crushing, a step of subjecting the magnetic powder to a heat treatment so as to form nanocrystal inside a particle of the magnetic powder, a step of subjecting a vicinity of a surface of the magnetic powder to a heat treatment so as to remove a protrusion portion on a particle surface of the magnetic powder or melting an acute angle portion of the particle surface so as to make a shape close to a spherical surface, and a step of press-molding a magnetic powder mixed by using magnetic powders having two or more kinds of sizes in which at least the surface is treated by the heat treatment.

In the method for producing a dust core of a sixth aspect according to the fifth aspect, the first magnetic powder which is at least a smaller one of the magnetic powders having two or more kinds of sizes may contain an element having a function of lowering a melting point of the iron.

In the method for producing a dust core of a seventh aspect according to the fifth aspect, a crystal structure in the second magnetic powder which is at least a larger one of the magnetic powders having two or more kinds of sizes may be a nanocrystal structure in which an average crystal particle size of the powder is 3 nm to 150 nm inclusive, or an amorphous structure coexisting with the nanocrystal structure.

Hereinafter, the dust core and the method for producing the same according to embodiments will be described with reference to the accompanying drawings.

### First Embodiment

### <Dust Core>

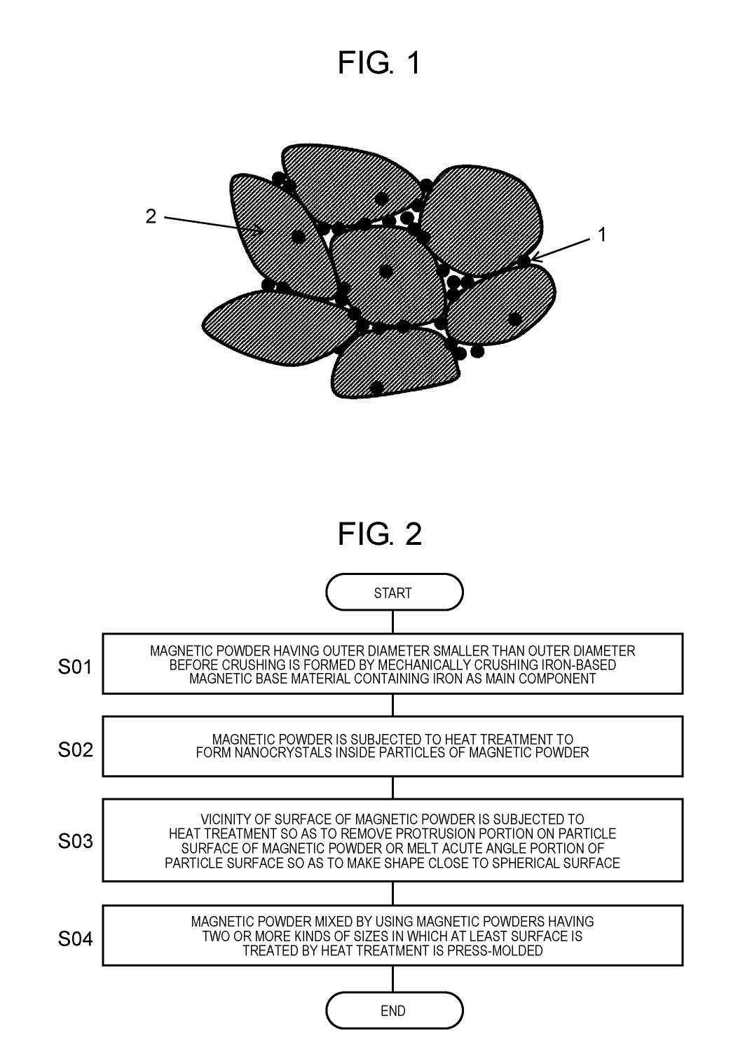

FIG. 1 is a diagram illustrating a sectional structure of a dust core according to a first embodiment.

This dust core is configured to include an iron-based magnetic powder containing iron as a main component. The iron-based magnetic powder has a first peak in a particle size distribution and a second peak corresponding to a particle size larger than the particle size corresponding to the first peak. The iron-based magnetic powder includes a first magnetic powder having the first peak and a second magnetic powder having the second peak. In the second magnetic powder, the crystal structure is a nanocrystal or amorphous structure. In addition, particle 1 of the first magnetic powder and particle 2 of the second magnetic powder are in a state of being bonded to each other.

According to this dust core, it is possible to realize an iron-based magnetic powder which can be compatible with a high filing rate while securing a desired nanocrystal structure, and a dust core using the magnetic powder. With this, it is possible to provide a dust core which has low core loss and high relative magnetic permeability.

### <Method for Producing Dust Core>

FIG. 2 is a flowchart of a method for producing the dust core according to the first embodiment. The method for producing the dust core includes the following steps. (a) A magnetic powder having an outer diameter smaller than an outer diameter before crushing is formed by mechanically crushing an iron-based magnetic base material containing iron as a main component (S01). (b) The magnetic powder is subjected to a heat treatment to form nanocrystals inside the particles of the magnetic powder (S02). (c) The vicinity of a surface of the magnetic powder is subjected to a heat treatment so as to remove a protrusion portion on a particle surface of the magnetic powder or melting an acute angle portion of the particle surface so as to make a shape close to a spherical surface (S03). (d) A magnetic powder mixed by using magnetic powders having two or more kinds of sizes in which at least the surface is treated by the heat treatment is press-molded (SO4).

Through the above-described steps, it is possible to obtain the dust core.

According to the method for producing the dust core, it is possible to obtain an iron-based magnetic powder which can be compatible with a high filing rate while securing a desired nanocrystal structure, and a dust core using the magnetic powder. With this, it is possible to provide a dust core which has low core loss and high relative magnetic permeability.

Hereinafter, the method for producing the dust core will be described in detail.

First, the iron-based magnetic powder containing iron as a main component and containing iron as a composition of 80 wt % or more was used as a raw material. The iron-based magnetic powder as a raw material was rapidly cooled from the liquid at a cooling rate of approximately 1000 K/sec or higher so as to prepare a thin band of the iron-based magnetic powder formed of an amorphous phase. Subsequently, a first heat treatment was performed on the obtained iron-based magnetic powder thin band at a temperature range of approximately 400° C. to 500° C. inclusive for 5 seconds to 300 seconds inclusive. As a result, a mixed phase was formed by recrystallizing the nanocrystal phase having an average crystal particle size of 5 nm to 30 nm inclusive in the amorphous phase. Thereafter, the heat-treated thin band was charged into a disintegrator and mechanically crushed by a jet mill method so as to form a magnetic powder.

Next, as a second heat treatment, the magnetic powder was charged into a thermal plasma generated under a reduced-pressure atmosphere at a controlled flow rate. The thermal plasma described here is a plasma which is close to a thermal equilibrium state and a gas temperature reaches several thousands ° C. to 10,000° C. inclusive. When the flow rate of the powder charged into the plasma is small, particles of the magnetic powder at the level of several μm are vaporized, and when the flow rate of is large, only the particle surface of the magnetic powder can be heated or melted. Further, in order to form an insulating film on the particle surface, the gas used for generating the plasma generates the plasma at a gas atmosphere mainly formed of a gas having low reactivity such as argon gas, nitrogen gas or the like and adding a small amount of oxygen or steam to generate plasma.

As the magnetic powder to be charged into the second heat treatment, the magnetic powders having at least two kinds of particle sizes were used. The first one is a second magnetic powder having a larger peak of the particle size distribution D50, and a heat treatment was performed as the aims of sphericalization and formation of an insulating film of the particle surface of the magnetic powder while maintaining the crystal structures inside the particles of the magnetic powder. The second one is the first magnetic powder having a smaller peak of the particle size distribution D50, and a heat treatment was performed as the aims of adding an element such as carbon to the inside of the particle and the particle surface of the magnetic powder and insulating at least the particle surface. At that time, CO₂ gas, CO gas, and CH₄ gas were used as the atmospheric gas as a supply source of carbon to the particle of the magnetic powder.

Next, the magnetic powder subjected to the second heat treatment was classified with each of a magnetic powder having a large particle size distribution D50 and a magnetic powder having a small particle size distribution D50. For the second magnetic powder having the larger particle size, the peak of D50 was set to be approximately 1 μm to 50 μm inclusive. For the first magnetic powder having the smaller particle size, the peak of D50 was set to be approximately 30 nm to 150 nm inclusive.

Three different kinds of impurities with different particle sizes were prepared for the first magnetic powder having the smaller particle size. In any of these cases, a matter in which carbon and oxygen are added as impurities into the magnetic powder was prepared by mixing at least one kind of CO₂ gas, CO gas, CH₄ gas, and oxygen as an atmospheric gas when performing the second heat treatment.

The kinds of verification conditions in this embodiment are indicated in Table 1 below.

TABLE 1

| | Condition | | Results | | |
|---|---|---|---|---|---|
| | Impurity | | | Magnetic properties | |
| | content | | | (Index) | |
| | (wt %) | | Filling | Relative magnetic | |
| Condition | Carbon | Oxygen | rate (%) | permeability | Core loss |
| Related art | 0.04 | 2.8 | 84 | 1.0 | 1.0 |
| example | | | | | |
| Condition 1 | 2.1 | 2.8 | 90.2 | 1.07 | 0.93 |
| Condition 2 | 4.3 | 2.6 | 91.7 | 1.10 | 0.83 |
| Condition 3 | 5.1 | 2.7 | 90.6 | 1.08 | 0.93 |
| Condition 4 | 4.2 | 23.0 | 93.3 | 1.13 | 0.77 |
| Condition 5 | 0.04 | 21.0 | 86.2 | 1.02 | 0.98 |

Table 1 illustrates the impurity content of the particles of the first magnetic powder having the smaller particle size and the result thereof. In the related art example, carbon was reduced to a level which is so-called pure iron, and oxygen was used at a level at which a natural oxide film was generally formed on the surface. In contrast, the conditions carried out in the present embodiment are indicated by Condition 1 to Condition 5, but in Condition 1, Condition 2, and Condition 3, for the purpose of verifying the effect due to the increase in carbon concentration, the carbon concentration is increased to 2.1 wt %, 4.3 wt %, and 5.1% while the oxygen concentration is set to be the same as that in the related art example.

In the iron-carbon system, the composition having the carbon concentration of Condition 3 in the vicinity of 4.3 wt % is generally called a eutectic point. In Condition 4, the oxygen concentration was increased to 23.0 wt % for the purpose of improving the effect due to the increase in the oxygen concentration while setting the carbon concentration to the eutectic point composition as in Condition 3.

In Condition 5, the oxygen concentration was set to 21.0 wt %, which was almost equal to Condition 4, while keeping the carbon concentration equal to that of the related art example for the purpose of verifying the effect due to the increase in the oxygen concentration.

Even with such conditions, the second magnetic powder having the larger particle size, in which the carbon concentration was set to be approximately 0.01 wt % to 0.04 wt % inclusive, and the oxygen concentration was set to be approximately 0.1 wt % to 1.0 wt % inclusive, was used.

Next, the magnetic powder having a large particle size and the magnetic powder having a small particle size were mixed and filled in a mold, and heated at 300° C. to 400° C. inclusive, and pressed at a pressure of approximately 100 MPa to 1000 MPa inclusive, and the surface of the particle of the magnetic powder was sintered so as to form a desired magnetic core shape.

FIG. 1 illustrates a schematic view of a dust core made of the magnetic powder prepared in this way. Table 1 also illustrates the filling rate and the magnetic properties as the verification results of the core.

As a tendency, an effect of improving the filling rate and improving the magnetic properties by adding each of or in combination of the carbon concentration and the oxygen concentration. In other words, as compared with the related art example, the relative magnetic permeability was 1.13 times higher and the core loss was 0.77 times lower.

As described above, the reason why high magnetism was obtained is presumed, but it is described below. The main reasons are considered that the magnetic powder having a small particle size is mixed and the particle size is reduced to the order of nm, and oxygen or carbon is added as an impurity to the magnetic powder having a small particle size. Even at a low temperature of 300° C. to 400° C. inclusive due to a melting point depression due to the size effect and melting point depression due to the additive element, the particle of the magnetic powder having a small particle size is set as a starting point, and the particle surface thereof is melted. As a result, it can be considered that the particle of the magnetic powder having a small particle size is bonded to the particle surface of the magnetic powder having a large particle size as if the particles of the magnetic powder having a large particle size are bound to each other, and the filling rate was able to be improved in roughly proportional to the bound amount.

Generally, it is known that as represented by Ag nanoparticles, when the particle size is reduced to 150 nm and 50 nm while a bulk has a high melting point of 961° C., a sintering temperature under 1 atmosphere is lowered to be about 200° C. and 150° C. That is, the melting point depression due to the size effect is considered as one of the reasons for the results obtained in this embodiment.

In general, although the melting point of pure iron is 1536° C., when carbon is contained in the pure iron, it is known that a dissolution onset temperature can be lowered by approximately 400° C. in a range of 2.1 wt % to 5.0 wt % inclusive, and the melting point of iron oxide (II) is 1370° C., and can be lowered by about 150° C. as compared with the melting point of the pure iron, and the reduction of the melting point depending on the additive element is considered as one of the reasons of the results obtained in the present embodiment.

Note that, by adding oxygen as an impurity to the first magnetic powder having a smaller particle size, it is possible to form a magnetic powder having a particle size in the order of nm without accompanying the danger of combustion due to abrupt oxidation.

The reason for charging the powder into the thermal plasma by the second heat treatment is that heating at high-speed and high-temperature becomes possible. It is possible to suppress a temperature rise of the inside of the particle while heating the particle surface of the magnetic powder to a level of several hundreds ° C. to 2000° C. inclusive by only being exposed to the plasma in a short time for approximately 0.05 sec to 2.00 sec inclusive. Therefore, particle growth of the crystal can be suppressed, and the inside of the particle can be maintained in a nanocrystal structure.

The reason for melting the particle surface of the magnetic powder is that the surface having an angular outer shape formed by mechanical disintegration can be melted by heat to bring it closer to a spherical surface, and the flowability and filling rate at the time of molding thereafter are increased. Another reason is that it is possible to prevent an increase in the magnetic properties, particularly coercive force, by relaxing the distortion of the particle surface of mainly magnetic powder introduced by mechanical disintegration.

Note that, in the second magnetic powder having a larger particle size of the magnetic powder, the peak of D50 is set to be approximately 1 μm to 50 μm inclusive, and in order to maintain high magnetism as an aggregate of powder, it is preferable to set the size within this range. If the particle size is smaller than 1 μm, it is presumed that the movement of a magnetic domain wall is hindered as a result; however, a hysteresis loss is increased, which is not preferable, and if the particle size is larger than 50 μm, an overcurrent loss of the inside of the particle becomes larger, and the feeling rate when being processed into a magnetic core is lowered, which is not preferable. Therefore, it is preferably about 1 nm to 50 nm inclusive.

The first magnetic powder having a smaller particle size among the magnetic powders has a peak of D50 of approximately 30 nm to 150 nm inclusive; however, in terms of melting point depression due to the size effect, the smaller the particle size is, the more preferable. However, when the particle size is smaller than 30 nm, it is difficult to form a contact point with the particle of the second magnetic powder having a larger particle size as the sintered body, which is not preferable for maintaining a molded body as a magnetic core. On the other hand, when the particle size is larger than 150 nm, the effect of the melting point depression cannot be practically obtained, which is not preferable. Therefore, it is preferably about 30 nm to 150 nm inclusive.

For the purpose of the melting point depression, only carbon is added as an impurity to the first magnetic powder having a smaller particle size, and only a case where the concentration is approximately 2.1 wt % to 5.0 wt % inclusive is disclosed. When the carbon concentration is lower than 2.1 wt %, a solidus wire of austenite remarkably changes to the higher temperature side, and thus it is difficult to obtain the effect of the melting point depression. In addition, in a case where the carbon concentration is set to around 4.3 wt %, the effect of the melting point depression is most exerted. Further, when the carbon concentration exceeds about 5.0 wt %, the hardness of the powder is remarkably increased, so that cracking and chipping are easily generated in the powder after sintering, which is not preferable because it is difficult to handle practically. Therefore, it is preferable that the carbon concentration is approximately 2.1 wt % to 5.0 wt % inclusive.

In addition, in a case of achieving the melting point depression due to the additive element, even in a case of adding sulfur of approximately 30 wt % to 35 wt % inclusive, or approximately 3 wt % to 5 wt % inclusive of boron (boron) instead of carbon, the same effect as that in the present embodiment can be obtained in principle.

Although only a case of the nanocrystal phase having an average crystal particle size of the magnetic powder of approximately 5 nm to 30 nm inclusive has been disclosed, it is practically difficult to uniformly and stably produce a state in which the average crystal particle size is smaller than 5 nm. On the other hand, when the average crystal particle size is larger than 30 nm, the effect of miniaturizing the crystal particle size is remarkably lost, and it becomes difficult to suppress loss such as the magnetic permeability or the coercive force. Therefore, it is preferably about 5 nm to 30 nm inclusive.

Although only the case where the thermal plasma method is applied as the second heat treatment has been disclosed, any method may be used as long as it can heat the particle surface of the magnetic powder at a high speed. For example, even with the surface heating method using microwaves, it is possible to obtain the same effect as that in the present embodiment. In this case, in order to uniformly irradiate the particle surface of the magnetic powder with the microwave, the microwave is irradiated with the magnetic powder in a state of being physically agitated, and thereby more excellent results can be obtained.

As the mechanical disintegration method, only a case of using the jet mill method has been disclosed; however, it is only necessary to process the particle size so that the particle size after disintegration may be several μm to several tens of μm in terms of the particle size of the second magnetic powder having the larger peak, and the particle size after disintegration may be several hundred nm to several μm in terms of the particle of the first magnetic powder having a smaller peak. Therefore, for example, even if a ball mill, a stamp mill, a planetary ball mill, a high speed mixer, a grinding machine, a pin mill, and a cyclone mill are used, the same effect as that in the present embodiment can be obtained.

Note that, the present disclosure includes appropriate combinations of any embodiment and/or example among the above-described various embodiments and/or examples, and exhibits an effect of each embodiment and/or example.

### INDUSTRIAL APPLICABILITY

According to the present disclosure, it is possible to provide an iron-based magnetic powder which can be compatible with a high filling rate while securing a desired nanocrystal structure, and a dust core which can be realized by using the powder, and has low core loss and high relative magnetic permeability.

### REFERENCE MARKS IN THE DRAWINGS

1 PARTICLE OF FIRST MAGNETIC POWDER

2 PARTICLE OF SECOND MAGNETIC POWDER

1. A dust core including an iron-based magnetic powder containing iron as a main component, comprising:
a first magnetic powder which has a first peak in a particle size distribution of the iron-based magnetic powder; and
a second magnetic powder which has a second peak corresponding to a particle size larger than a particle size corresponding to the first peak in the particle size distribution of the iron-based magnetic powder, the second magnetic powder having a crystal structure which is nanocrystal or amorphous,
wherein a particle of the first magnetic powder and a particle of the second magnetic powder are in a state of being bonded to each other.

2. The dust core of claim 1,
wherein the first magnetic powder contains more carbon than the second magnetic powder contains.

3. The dust core of claim 1,
wherein the first magnetic powder contains more oxygen atoms than the second magnetic powder contains.

4. The dust core of claim 1,
wherein an average crystal particle size of the second magnetic powder is in a range of 5 nm to 30 nm inclusive.

5. A method for producing a dust core comprising:
a step of mechanically crushing an iron-based magnetic base material containing iron as a main component so as to form a magnetic powder having an outer diameter smaller than an outer diameter before the crushing;
a step of subjecting the magnetic powder to a heat treatment so as to form nanocrystal inside a particle of the magnetic powder;
a step of subjecting a vicinity of a surface of the magnetic powder to a heat treatment so as to remove a protrusion portion on a particle surface of the magnetic powder or melting an acute angle portion of the particle surface so as to make a shape close to a spherical surface; and
a step of press-molding a magnetic powder mixed by using magnetic powders having two or more kinds of sizes in which at least the surface is treated by the heat treatment.

6. The method for producing a dust core of claim 5,
wherein the first magnetic powder which is at least a smaller one of the magnetic powders having two or more kinds of sizes contains an element having a function of lowering a melting point of the iron.

7. The method for producing a dust core of claim 5,
wherein a crystal structure in the second magnetic powder which is at least a larger one of the magnetic powders having two or more kinds of sizes is a nanocrystal structure having an average crystal particle size of the powder 3 nm to 150 nm inclusive, or an amorphous structure coexisting with the nanocrystal structure.
